(19) United States
(12) Patent Application Publication
(10) Pub. No.: US 2018/0347610 A1
(43) Pub. Date: Dec. 6, 2018

(54) FASTENERS FOR ROADBED CONSTRUCTION

(71) Applicant: Zebulon Zuk, Ham Lake, MN (US)

(72) Inventor: Zebulon Zuk, Ham Lake, MN (US)

(21) Appl. No.: 15/948,077

(22) Filed: Apr. 9, 2018

Related U.S. Application Data
(63) Continuation-in-part of application No. 15/689,276, filed on Aug. 29, 2017, now abandoned.
(60) Provisional application No. 62/515,334, filed on Jun. 5, 2017.

(51) Int. Cl. F16B 15/00; F16B 15/06; E01C 11/14; E01C 11/18

(52) U.S. Cl. CPC F16B 15/0015; F16B 15/06; F16B 15/0092; E01C 11/18; E01C 11/14

(57) ABSTRACT

Fasteners for securing reinforcing structures, such as rebar, to road beds prior to laying the road material, such as concrete or asphalt. The fasteners are particularly suited for use when a geotextile fabric, or other underlayment, is present between the reinforcing structure and the road bed. The fasteners have at least one leg having an end and an opposite end, such as a self-centering end or a radiused end. In use, a fastener is positioned over a reinforcing structure with the leg(s) extending alongside the reinforcing structure and the radiused end extending over the structure. Applying force (e.g., percussive force) to the end, such as by pounding or hammering, will drive the fastener through the fabric and fasten the reinforcing structure to the fabric.

### CROSS-REFERENCE

This application is a continuation-in-part application of U.S. application Ser. No. 15/689,276 filed Aug. 29, 2017, which claims priority to, and the benefit of, U.S. provisional patent application 62/515,334 filed Jun. 5, 2017, the entire disclosures of all are incorporated herein by reference for all purposes.

### BACKGROUND

The present disclosure relates to road construction processes, more particularly to reinforced concrete road beds, slabs, or plates having expansion joints.

Reinforcing inserts, such as steel mats or rebar structures, are placed in concrete road slabs or plates to prevent or at least inhibit the formation of cracks caused by transverse and longitudinal tensile stress caused by loads to which the slabs are subjected during use by traffic. Typically, the formation of cracks is decreased by including a reinforcing structure within the slab.

Expansion joints are also placed in the concrete, not only to allow for expansion and contraction of the concrete, but also to provide a pre-cracked location. The areas proximate the expansion joints are reinforced by a connecting structure extending across the joints between adjacent slabs.

The reinforcing inserts, including those at joints, are typically secured to the base road bed prior to laying the concrete.

### SUMMARY

Implementations described and claimed herein provide a fastener for securing a bar or rod-type structure to an underneath structure, such as thin, flexible material, e.g., a fabric, netting, webbing, sheet, etc. As an example, the fastener is suited for securing reinforcing inserts to road beds, particularly for when a geotextile fabric, or other underlayment, is present between the reinforcing insert and the road bed. As another example, the fastener is suited for securing fiber rolls to geotextile fabric for erosion control.

This disclosure provides, in one particular implementation, a method for securing a reinforcing structure, e.g., to a layer of a road construction, such as to and/or through a geotextile material on a road bed. The method includes placing a fastener having a planar leg with a point at a first end and an end, e.g., a radiused end, a self-centering end, at a second end opposite the first end proximate a reinforcing structure, the end at an angle between about 120 and about 150 degrees to the planar leg, the planar leg extending alongside the reinforcing structure and the end extending at least partially over the reinforcing structure. In some designs, the end is a radiused end, with all or a portion of the end defined by a radius, whereas in other designs, the end is polygonal end, which may have a self-centering configuration. The fastener may, in some designs, have two essentially parallel legs that join at the end; such a fastener is placed with the reinforcing structure between the legs and the end extending across the reinforcing structure. In other designs, the legs may not be parallel, but may have a region that narrows or expands. The method further includes applying pressure (e.g., percussive pressure, e.g., with a hammer) to the end of the fastener to force the fastener into any material below the reinforcing structure, such as through a fabric or geotextile material positioned below the reinforcing structure, e.g., above the road bed and/or into a compacted (e.g., rock) road bed. In some implementations, rather than a compacted road bed, the fabric or geotextile material is positioned over a previous, old (and hence, deteriorated) road.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. These and various other features and advantages will be apparent from a reading of the following detailed description.

### BRIEF DESCRIPTIONS OF THE DRAWING

The described technology is best understood from the following Detailed Description describing various implementations read in connection with the accompanying drawing.

FIG. 1 is a schematic perspective view of a road under construction.

FIG. 2A is a perspective view of a fastener; FIG. 2B is a side view of the fastener of FIG. 2A; FIG. 2C is an end view of the fastener of FIG. 2A; FIG. 2D is a perspective view of an alternate implementation of a fastener; FIG. 2E is an end view of an alternate implementation of a fastener; FIG. 2F is a side view of an alternate implementation of a fastener; FIG. 2G is a top view of a portion of an alternate implementation of a fastener; FIG. 2H is a top view of a portion of an alternate implementation of a fastener; FIG. 2I is a top view of a portion of an alternate implementation of a fastener; and FIG. 2J is a top view of a portion of an alternate implementation of a fastener.

FIG. 3A is a schematic perspective view of a reinforcing structure secured by a fastener; FIG. 3B is an enlarged schematic side view of the fastener securing the reinforcing structure; FIG. 3C is a schematic top perspective view of the fastener securing a portion of the reinforcing structure.

FIG. 4 is a top plan view of a fastener securing a portion of a reinforcing structure.

### DETAILED DESCRIPTION

The present disclosure provides fastener articles and processes for securing a reinforcing structure to a flexible underlayment, such as a flexible material. In some implementations, the reinforcing structure is a basket or rebar structure for a road bed. Although the reinforcing structures are typically used for concrete roads, the fastener and processes disclosed herein could be applied to asphalt roads or other applications where a horizontal member needs to be fastened down. For example, the fasteners and process could be used for soil erosion abatement, securing fiber rolls (e.g., straw rolls) to geotextile material. Of course, the fasteners and process could be used in other applications.

The following description provides specific implementations of a fastener and its use. It is to be understood that other implementations are contemplated and may be made without departing from the scope or spirit of the present disclosure. For example, although the term “fastener” is used throughout, it is understood the device could also be referred to as an anchor, a staple, an attachment, a connector, a stake, etc. The following detailed description, therefore, is not to be taken in a limiting sense. While the present disclosure is not so limited, an appreciation of various aspects of the disclosure will be gained through a discussion of the examples provided below.

In the following description, reference is made to the accompanying drawing that forms a part hereof and in which are shown by way of illustration at least one specific implementation. In the drawing, like reference numerals may be used throughout several figures to refer to similar components. In some instances, a reference numeral may have an associated sub-label consisting of an upper-case letter to denote one of multiple similar components. When reference is made to a reference numeral without specification of a sub-label, the reference is intended to refer to all such multiple similar components.

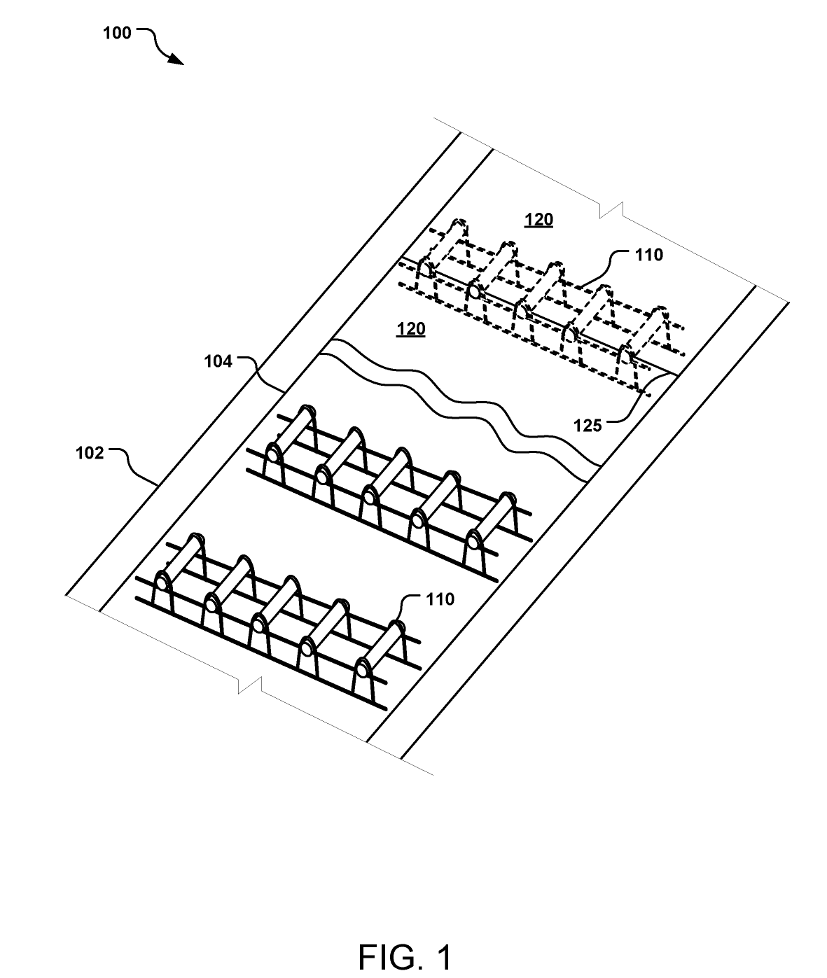

FIG. 1 shows schematically and generically a typical methodology for constructing a concrete road 100. A road bed 102 is prepared, typically from material such as crushed rock, gravel, crushed asphalt, and/or other aggregate or filler. The road bed 102 is compacted, as is well known in the field, and often covered with a geotextile fabric 104. In other implementations, commonly referred to as unbonded concrete overlay, an old, deteriorated road (e.g., asphalt road) rather than a new road bed, is overlaid with geotextile fabric 104. For such a construction, the fabric 104 inhibits the cracks in the old road from propagating to the new road. Reinforcing structures 110, also commonly referred to as baskets or cages, are placed on the fabric 104 and secured to the fabric 104. The road bed 102, fabric 104 and reinforcing structures 110 are covered by and encased in concrete 120 to form the new, concrete road 100. The reinforcing structure 110 provides tensile strength and load transfer between adjacent panels in a completed road, inhibiting cracking of the concrete 120. In some constructions, joints 125 are present between slabs or regions of concrete. These joints 125 may be present as expansion joints and/or as a stress (crack) relief. In some constructions, a reinforcing structure 110 is positioned to span across a joint 125, stabilizing the joint 125 and transferring the load between two concrete slabs.

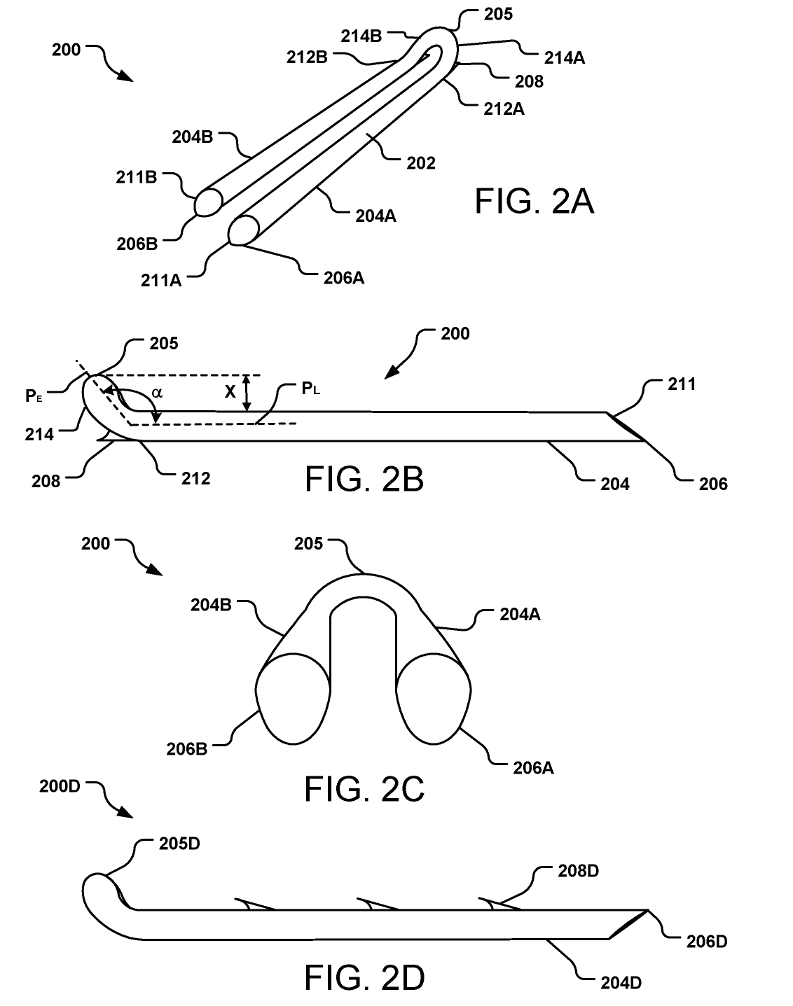

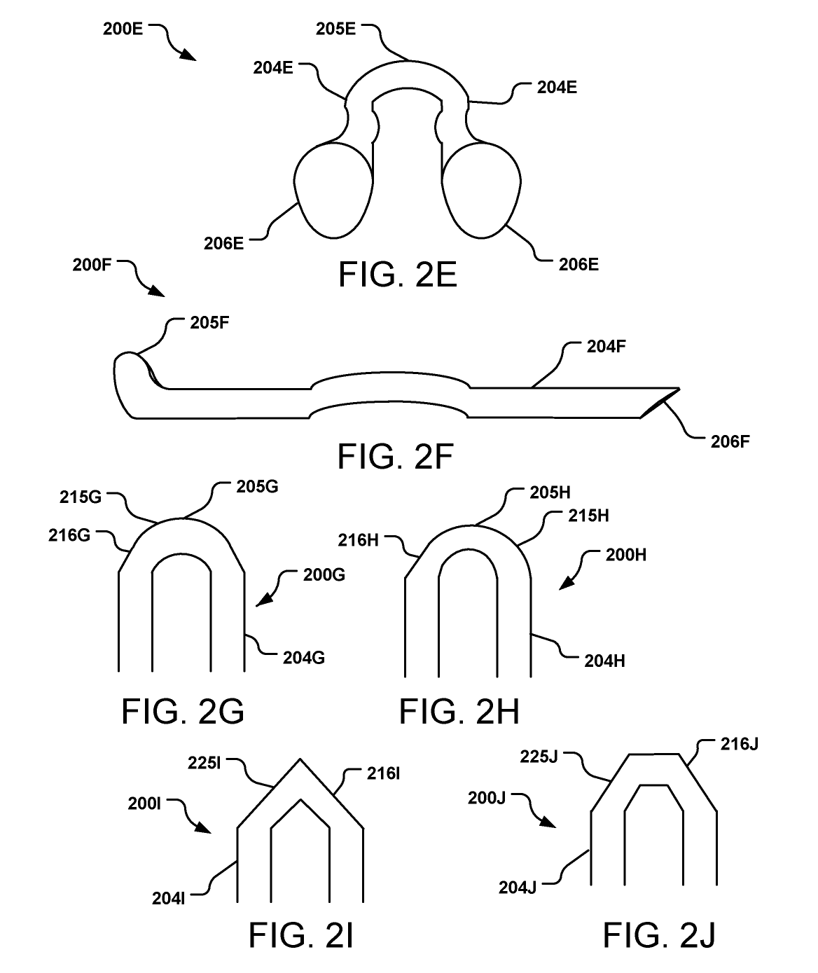

FIGS. 2A, 2B and 2C illustrate an example fastener 200 for securing a reinforcing structure (e.g., basket), such as to the geotextile fabric and optionally the road bed of FIG. 1. However, as indicated above, the fastener 200 and variations thereof can be used for other applications

The fastener 200 can be described generically as a staple, having a body 202 with at least one leg 204. The fastener 200 has two legs 204A, 204B, which may be parallel or may be slightly at an angle to each other; the legs 204 may have the same or different lengths. Example lengths include 2 inches, 2½ inches, 3 inches, 4 inches, etc., although any longer or shorter length is feasible. Best seen in FIG. 2B, legs 204 extend in a generally planar or straight manner with a constant diameter, although in some implementations they may be tapered or have other features. The legs 204A, 204B terminate at a tip 206A, 206B, respectively, which can be pointed, beveled, angled, or otherwise at a lesser diameter than the legs 204, or the tip 206 can be a blunt or rounded end. The tip 206, e.g., a tapered, beveled, angled tip, may be jagged due to notches, or may be forked. The point, notches, etc. may be centered on the tip 206 or may be offset. For example, the fastener 200 of FIGS. 2A, 2B and 2C has the tips 206 angled one direction, downward from the top side of the legs 204 to the bottom side, whereas the implementation of FIG. 2D, which is a fastener 200D having legs 204D that extend from tips 206D to a radiused end 205D, has the tips 206D angled the other direction.

Returning to FIGS. 2A, 2B and 2C, the legs 204 meet at a radiused end 205 opposite the tips 206. The radiused end 205 may have a constant radius across the entire end 205, or the radius may differ, forming, e.g., an oval shape. Other examples of radiused ends are shown, e.g., in FIGS. 2E, 2G and 2H, below. In a preferred design, the fastener 200 is formed from a single piece (e.g., metal bar, rod) of material that is bent, so that the bent portion is the radiused end 205. In alternate implementations, the fastener 200 can be molded, cast, extruded, or formed by any combination of methods. Examples of suitable materials for the fastener 200 include metal (e.g., iron, steel, stainless steel) and plastics. The fastener material may have any coating thereon, such as nickel plating, corrosion resist, concrete primer, etc.

Best seen in FIG. 2B, the end 205 is angled out of the plane of the legs 204. The angle α formed by the radiused end 205, in relation to the legs 204, is at least 100 degrees and no greater than 170 degrees. In some implementations, the angle α is between about 105 degrees and about 165 degrees, or in other implementations between about 120 degrees and about 150 degrees, and yet in other implementations between about 125 and 140 degrees. Specific examples of suitable angles α include 130 degrees, 135 degrees, 140 degrees, and 145 degrees. This angling of the radiused end 205 can improve the seating of the fastener 200 against a structure, such as the reinforcing structure 110.

The top of the radiused end 205 is sufficiently displaced from the legs 204 a distance X, as will be described below. Assuming the material (e.g., steel rod, iron stock, etc.) that forms the fastener 200 is a constant or essentially constant diameter for the legs 204 and the radiused end 205, this distance X is the same whether measured from the two of the legs 204 to the top of the radiused end 205 (as shown in FIG. 2B) or if measured from the bottom of the legs 204 to the bottom of the rod at the radiused end 205. This distance X is greater than the diameter of the reinforcing structure which the fastener will fasten; additional discussion regarding this offset distance X is below.

The fastener 200 includes a barb 208 proximate the radiused end 205 extending out from the legs 204. Barb 208 inhibits retraction of the fastener 200 after the fastener 200 has been inserted through a material, as described below. The fastener 200 has the barbs 208 located on the bottom side of the legs 204, proximate the radiused end 205. In such a design, the barbs 208 are protected by the radiused end 205 because the barbs 208 do not extend past the radiused end 205 and are not exposed; this protects the barbs 208 from damage, such as during installation of the fastener 200. The fastener 200D of FIG. 2D has multiple barbs 208D on each leg 204D, equally spaced along the length of the legs 204D on the top side of the legs 204D. Alternate designs may have barbs on the inside of the legs, the barbs on the legs either being offset from each other or aligned with each other.

FIGS. 2E through 2J illustrate various alternate designs of fasteners.

FIG. 2E shows a fastener 200E having two legs 204E extending from a radiused end 205E to tips 206E. The view of the fastener 200E in FIG. 2E is similar to the view of the fastener 200 in FIG. 2C, and the legs 206E can be readily seen. In this implementation, the legs 204E are not parallel, but have an inward pinch or bend at a region in the legs 206E; such a pinched feature facilitates gripping the reinforcing structure when the fastener 200E is installed.

FIG. 2F shows a fastener 200F having two legs 204F extending from a radiused end 205F to tips 206F. The view of the fastener 200F in FIG. 2F is similar to the view of the fastener 200 in FIG. 2B, and the legs 206F can be readily seen. In this implementation however, the legs 204F are not planar, but have an upward bend out of the plane in the direction of the radiused end 205F. The tips 206F are, however, planar with the legs 206F proximate the radiused end 205F.

FIG. 2G shows a portion of a fastener 200G having two legs 204G extending from a radiused end 205G. In this implantation, the radiused end 205G is symmetrical with a radiused portion 215G and with transitions portions 216G that form an angled connection to the legs 204F.

FIG. 2H shows a portion of a fastener 200H having two legs 204H extending from a radiused end 205H. In this implantation, the radiused end 205H is asymmetrical, with a radiused portion 215H and one transition portion 216H that forms an angled connection to one of the legs 204H.

FIGS. 2I and 2J show fasteners with a polygonal end rather than a radiused end. FIG. 2I shows a portion of a fastener 200I having two legs 204I extending from a polygonal end 225I. In this implementation, the polygonal end 225I has two portions 216I that form a triangular inner region for accepting the reinforcing structure therein. FIG. 2J shows a portion of a fastener 200J having two legs 204J extending from a polygonal end 225J. In this implementation, the polygonal end 225J has three portions 216J that form a hexagonal inner region for accepting the reinforcing structure therein.

For fasteners with polygonal ends, although not required, it is desired that the polygonal end provides an inner region that is self-centering on the reinforcing structure; this can be readily accomplished with a number of portions that form a symmetric end with a centered inner receptacle or region (e.g., two portions form a triangular inner area as in FIG. 2I, three portions form a hexagonal inner area as in FIG. 2J, etc.). In other implementations, although possible but not desired, the polygonal end can form an inner region that does not include a central, self-centering inner receptacle or region; an example of such an end would be a square end. However, in some implementations, depending on the dimensions of the fastener in relation to the reinforcing structure being held, a square end could be self-centering.

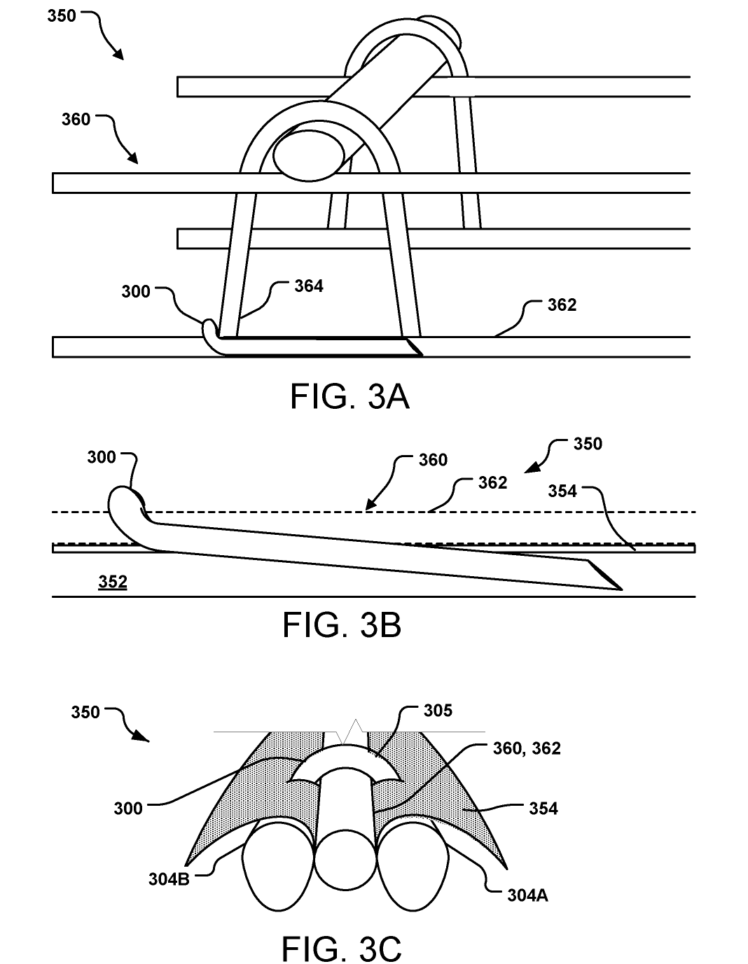

FIGS. 3A, 3B and 3C illustrate an application 350 of how a fastener 300, similar to the fastener 200, can be used to fasten a reinforcing structure 360 (e.g., a basket) to and through a geotextile fabric 354 positioned above a road bed 352. In FIG. 3A, the reinforcing structure 360 is shown having an elongate lower member 362, typically a rebar-type member, that extends along the surface (e.g., a geotextile fabric) to which the structure 360 will be fastened. The reinforcing structure 360, in this design of the reinforcing structure 360, includes multiple vertical members 364 extending orthogonally to (or close to orthogonally to) and above the lower members 362. The fastener 300 fits over the elongate lower member 362, with the legs 304 of the fastener 300 extending parallel to, and in some embodiments immediately adjacent to, the elongate lower member 362. The radiused end 305 of the fastener 300 sits over and/or on the elongate lower member 362.

This engagement between the elongate lower member 362, the fabric 354 and the fastener 300 is shown in more detail in FIG. 3B, where the fastener 300 is shown positioned over and alongside the elongate lower member 362, penetrated through the fabric 354 and slightly into the road bed 352; each of the two legs 304 is positioned on a side of the lower member 362 and extending alongside the lower member 362. In other implementations, the fastener 300 penetrates through the fabric 354 and does not penetrate into, but rides above, the road bed 352. An alternate implementation of the fastener 300 may have a secondary leg parallel to each of the primary legs 304 to receive the fabric 354 there between.

The radiused end 305 is displaced from the legs 304 the distance X so that the end 305 extends over and across the elongate lower member 362. This distance X, in typical implementations, is greater than the diameter of the lower member 362, to allow the radiused end 305 to extend over the member 362 while having the legs 304 penetrate a material below the lower member 362. Typical diameters of material (e.g., steel, iron) used for the reinforcing structure 360 and/or the lower member 362 are ¼ inch, ½ inch, ⅜ inch, ⅝ inch, and the like; thus, the distance X is at least ¼ inch, ½ inch, ⅜ inch, ⅝ inch, etc., respectively.

FIG. 3C shows in detail the relationship of the elongate lower member 362 of the reinforcing structure 360, the fabric 354 and the fastener 300 with the fastener 300 installed. Particularly seen is how the legs 304 of the fastener 300 extend alongside the lower member 362. Additionally, it is seen how the legs 304 are under the fabric 354, yet the radiused end 305 is above and over the fabric 354 and the elongate lower member 362.

To install the fastener 300 so that it secures the reinforcing structure 360 to the fabric 354, the fastener 300 is placed over and aligned essentially parallel with the elongate lower member 362. The fastener 300 may be positioned so that, when installed, the fastener 300 is proximate a vertical member 364 of the reinforcing structure 360, e.g., the radiused end 305 seats against or close to a vertical member 364; the angle of the radiused end 305 can be such that it improves the seating of the fastener 300 against the vertical member 364. Alternately, the fastener 300 may be positioned so that when installed, the fastener 300 is not adjacent to or proximate a vertical member 364, but is displaced therefrom. A hole may be formed in the fabric 354 where it is desired for the tips 306 to pass through the fabric 354, particularly if the tips 306 of the fastener 300 are blunt, however, depending on any point of the tips and the fabric itself, a hole may not be needed. After being positioned over and aligned with the elongate lower member 362, the fastener 300 can be hit or tapped (e.g., with a hammer) on the radiused end 305 to drive the fastener 300 through the fabric 354, preferably against and in contact with the lower member 362, and optionally against the vertical member 364. In some implementations, a portion of the fastener 300 (e.g., the tips 306 and part of the legs 304) may dig into and seat in the road bed 352.

The fastener 300 can be driven through the fabric 354 either manually or with power tool(s). The fastener 300 may include a tang, hook, tab or other element to facilitate feeding into or being held by a power tool.

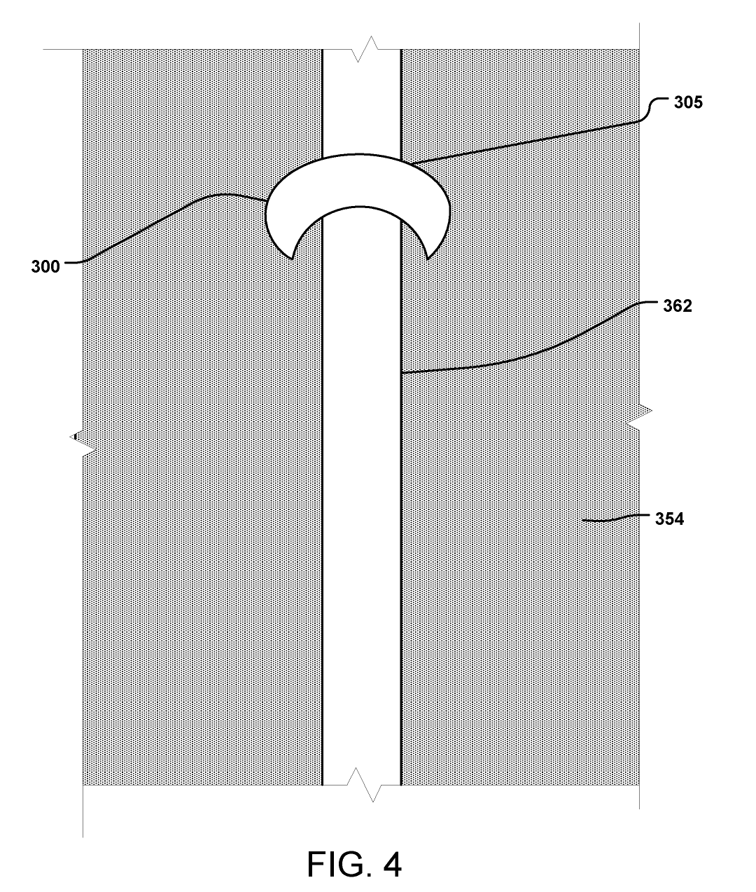

FIG. 4 illustrates the resulting view of the fastener 300 holding the reinforcing structure 360 (particularly, the elongate lower member 362) to the fabric 354.

For implementations with a fastener having only one leg (rather than two legs), the fastener has the leg and a radiused end opposite the tip of the leg. A fastener having one leg (rather than two legs) will not be exactly half of a fastener having two legs (e.g., formed by the one-legged fastener having been cut through a longitudinal axis of the two-legged fastener), but rather, the one-legged fastener will have all or close to all of the radiused end. This allows a one-legged fastener to still extend over the lower horizontal member of a reinforcing structure to fasten the reinforcing structure to the fabric or other material below the reinforcing structure.

The above specification provides a description of the structure and use of exemplary implementations of the invention. The above description provides specific implementations. It is to be understood that any of the features provided for a specific implementation may be applied to any of the other implementations; that is, features may be exchanged and interchanged among the implementations. Other implementations are contemplated and may be made without departing from the scope or spirit of the present disclosure. The above detailed description, therefore, is not to be taken in a limiting sense. While the present disclosure is not so limited, an appreciation of various aspects of the disclosure will be gained through a discussion of the examples provided.

Unless otherwise indicated, all numbers expressing feature sizes, amounts, and physical properties are to be understood as being modified by the term “about.” Accordingly, unless indicated to the contrary, any numerical parameters set forth are approximations that can vary depending upon the desired properties sought to be obtained by those skilled in the art utilizing the teachings disclosed herein.

As used herein, the singular forms “a”, “an”, and “the” encompass implementations having plural referents, unless the content clearly dictates otherwise. As used in this specification and the appended claims, the term “or” is generally employed in its sense including “and/or” unless the content clearly dictates otherwise.

Spatially related terms, including but not limited to, “bottom,” “lower”, “top”, “upper”, “beneath”, “below”, “above”, “on top”, “on,” etc., if used herein, are utilized for ease of description to describe spatial relationships of an element(s) to another. Such spatially related terms encompass different orientations of the device in addition to the particular orientations depicted in the figures and described herein. For example, if a structure depicted in the figures is turned over or flipped over, portions previously described as below or beneath other elements would then be above or over those other elements.

Since many implementations of the invention can be made without departing from the spirit and scope of the invention, the invention resides in the claims hereinafter appended. Furthermore, structural features of the different implementations may be combined in yet another implementation without departing from the recited claims.

1. A method of securing a structure, the method comprising:
placing a fastener, the fastener comprising two legs defining a plane, each leg extending from a tip at a first end to a second opposite end, each second end continuing to a transition portion, the legs joined only at a radiused end formed by the transition portions of the legs, the radiused end and the transition portions defining a plane, the plane positioned at an angle between about 100 degrees and about 170 degrees to the plane of the legs, proximate a horizontal member of a structure, the planar legs extending on either side of the horizontal member of the structure and the radiused end extending over the horizontal member of the structure, and
applying pressure to the radiused end of the fastener to force the fastener through a material positioned below the reinforcing structure, with the legs extending alongside the horizontal member and the radiused end extending over the horizontal member.

2. (canceled)

3. (canceled)

4. (canceled)

5. The method of claim 1, wherein after applying pressure to the radiused end, the radiused end extends over and contacts the horizontal member.

6. The method of claim 1, wherein after applying pressure to the radiused end, the radiused end extends over the horizontal member proximate to a vertical member of the structure.

7. The method of claim 6, wherein after applying pressure to the radiused end, the radiused end extends over and contacts the horizontal member and the vertical member.

8. (canceled)

9. (canceled)

10. The method of claim 1, wherein the fastener comprises two planar legs each having a point at the first end.

11. A fastener comprising two legs defining a plane, each leg extending from a tip at a first end to a second opposite end, each second end continuing to a transition portion, the legs joined only at a radiused end formed by the transition portions of the legs, the radiused end and the transition portions defining a plane, the plane positioned at an angle between about 100 degrees and about 170 degrees to the plane of the legs.

12. The fastener of claim 11, wherein the plane defined by the radiused end and the transition portions forms an angle between about 120 degrees and about 150 degrees to the plane of the legs.

13. The fastener of claim 11, wherein the plane defined by the radiused end and the transition portions forms an angle between about 125 degrees and about 140 degrees to the plane of the legs.

14. The fastener of claim 11, further comprising at least one barb.

15. The fastener of claim 11, wherein the at least one barb extends from one of the legs proximate the radiused end.

16. A fastener comprising two legs defining a plane, each leg extending from a tip at a first end to a second opposite end, each second end continuing to a transition portion, the legs joined only at a self-centering end formed by the transition portions of the legs, the self-centering end and the transition portions defining a plane, the plane positioned at an angle between about 100 degrees and about 170 degrees to the plane of the legs.

17. The fastener of claim 16, wherein the plane defined by the self-centering end and the transition portions forms an angle between about 120 degrees and about 150 degrees to the plane of the legs.

18. The fastener of claim 16, wherein the plane defined by the self-centering end and the transition portions forms an angle between about 125 degrees and about 140 degrees to the plane of the legs.

19. The fastener of claim 16, further comprising at least one barb extending from one of the legs proximate the self-centering end.

20. The fastener of claim 16, wherein the self-centering end is a radiused end.

21. The fastener of claim 16, wherein the two legs are parallel.

22. The fastener of claim 11, wherein the two legs are parallel.

23. The method of claim 1, the fastener further comprising at least one barb extending from one of the legs.
